(19) United States
(12) Patent Application Publication
(10) Pub. No.: US 2024/0091955 A1
(43) Pub. Date: Mar. 21, 2024

(54) SYSTEM AND METHOD FOR AUTONOMOUSLY SUPPORTING OPERATORS PERFORMING PROCEDURES WITHIN A FACILITY

(71) Applicant: Apprentice FS, Inc., Jersey City, NJ (US)

(72) Inventors: Frank Maggiore, Jersey City, NJ (US); Angelo Stracquatanio, Jersey City, NJ (US); Abdel Hassan, Jersey City, NJ (US)

(21) Appl. No.: 18/511,656

(22) Filed: Nov. 16, 2023

Related U.S. Application Data
(63) Continuation-in-part of application No. 18/120,284, filed on Mar. 10, 2023.
Application No. 18/120,284 is a continuation-in-part of application No. 18/120,292, filed on Mar. 10, 2023.
(60) Provisional application No. 63/426,462, filed on Nov. 18, 2022.
(60) Provisional application No. 63/426,484, filed on Nov. 18, 2022.
(60) Provisional application No. 63/426,480, filed on Nov. 18, 2022.
(60) Provisional application No. 63/318,912, filed on Mar. 11, 2022.
(60) Provisional application No. 63/347,339, filed on May 31, 2022.
(60) Provisional application No. 63/426,471, filed on Nov. 18, 2022.
(60) Provisional application No. 63/318,912, filed on Mar. 11, 2022.
(60) Provisional application No. 63/347,339, filed on May 31, 2022.
(60) Provisional application No. 63/426,471, filed on Nov. 18, 2022.

(51) Int. Cl. B25J 11/00; B25J 5/02; B25J 9/16

(52) U.S. Cl. CPC B25J 11/008; B25J 5/02; B25J 9/1664

(57) ABSTRACT

A method for delivering materials includes: at a loading system located within a sanitary zone at the facility, accessing a materials manifest specifying compliant materials associated with the manufacturing operation; in response to identifying compliant materials at the loading system corresponding to the materials manifest, assigning the compliant materials a delivery location within the facility and a baseline material compliance score; triggering a loading system to load the compliant materials onto an autonomous cart; triggering the autonomous cart to maneuver the compliant materials from a first zone to the delivery location within a second zone at the facility; calculating a material compliance score of the tray based on the locations traversed by the autonomous cart; and, in response to the material compliance score exceeding a threshold score, triggering the autonomous cart to maintain an offset distance from an operator at the delivery location.

### CROSS-REFERENCE TO RELATED APPLICATIONS

This Application claims the benefit of U.S. Provisional Application No. 63/426,462, filed on 18 Nov. 2022, 63/426,484, filed on 18 Nov. 2022, and 63/426,480, filed on 18 Nov. 2022, each of which is hereby incorporated in its entirety by this reference.

This Application is a continuation-in-part of U.S. Non-Provisional application Ser. No. 18/120,284, filed on 10 Mar. 2023, and Ser. No. 18/120,292, filed on 10 Mar. 2023, each of which claims the benefit of U.S. Provisional Application No. 63/318,912, filed on 11 Mar. 2022, 63/347,339, filed on 31 May 2022, and 63/426,471, filed on 18 Nov. 2022, each of which is hereby incorporated in its entirety by this reference.

This Application is related to U.S. Non-Provisional Application Nos. 17/719,120, filed on 12 Apr. 2022, and Ser. No. 17/968,684, filed on 18 Oct. 2022, each of which is hereby incorporated in its entirety by this reference.

### TECHNICAL FIELD

This invention relates generally to the field of pharmacological manufacturing and more specifically to a new and useful method for autonomously deploying a utility cart to support production of pharmacological materials in the field of pharmacological manufacturing.

### BRIEF DESCRIPTION OF THE FIGURES

FIG. 1 is a flowchart representation of the method;

FIG. 2 is a flowchart representation of the method;

FIG. 3 is a flowchart representation of the method;

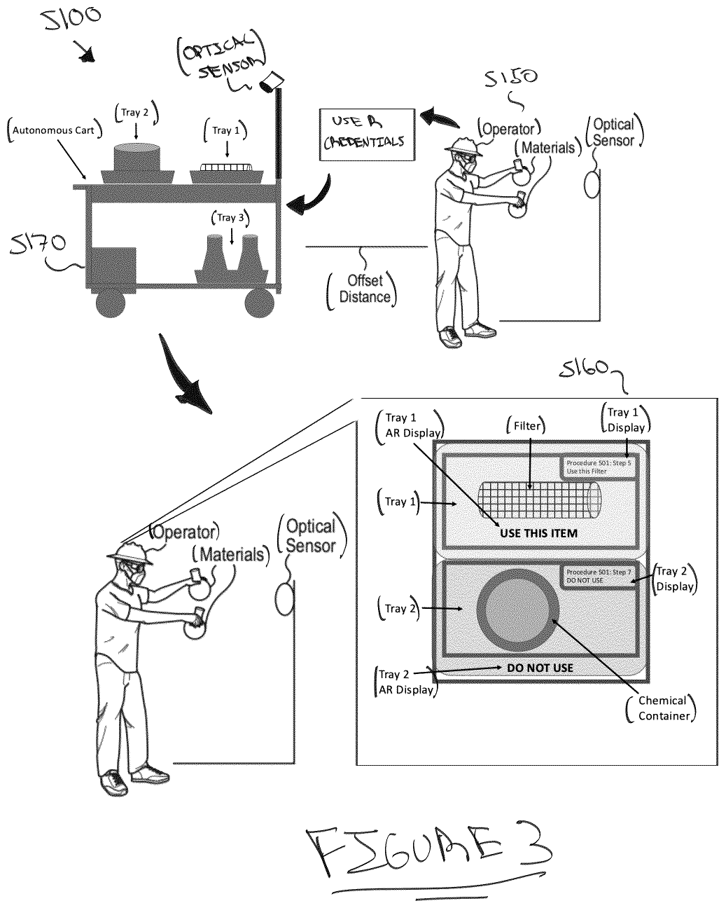

FIG. 4 is a flowchart representation of the method; and

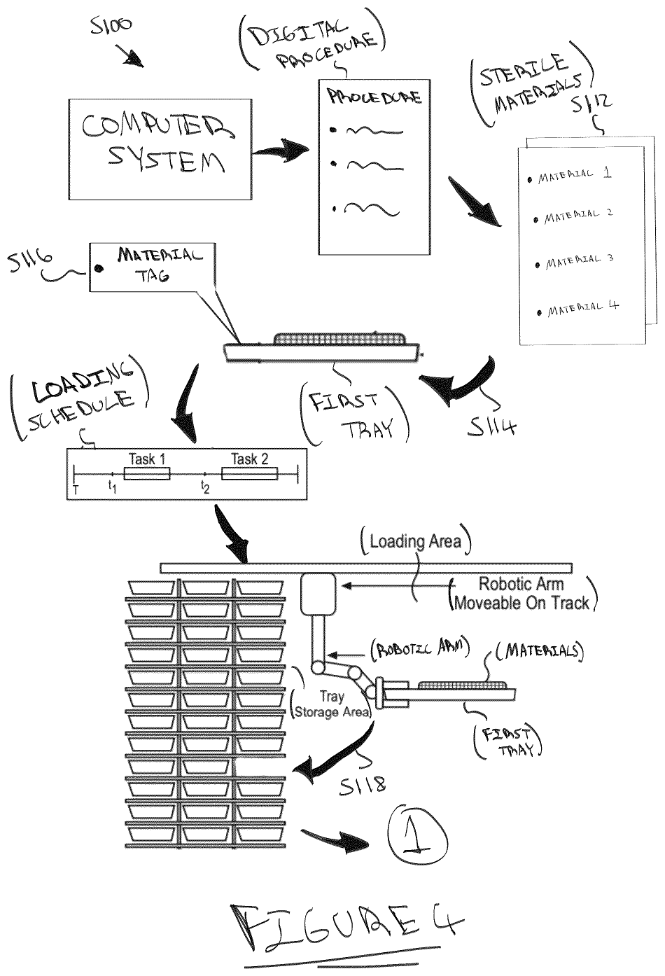

FIG. 5 is a flowchart representation of the method.

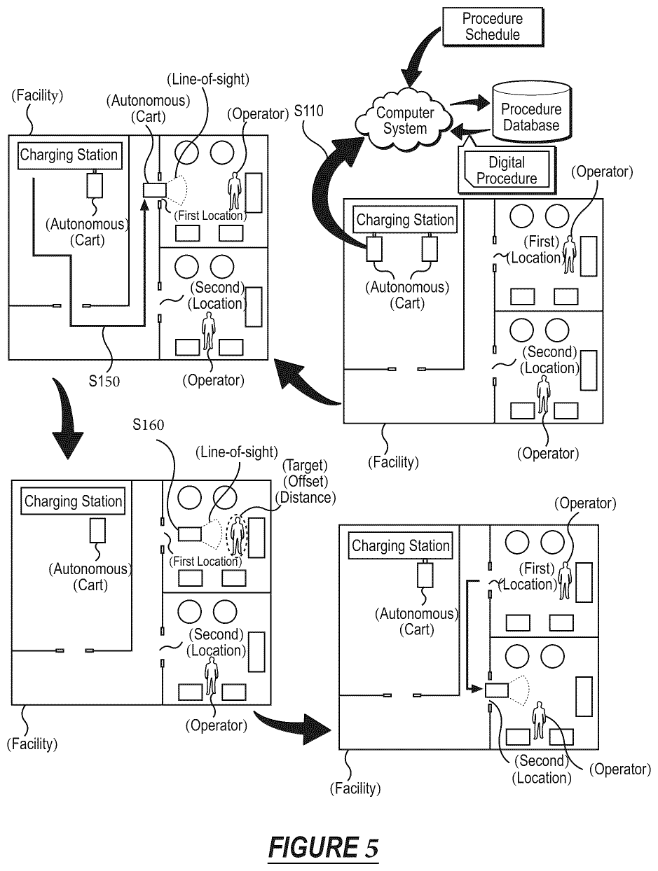

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

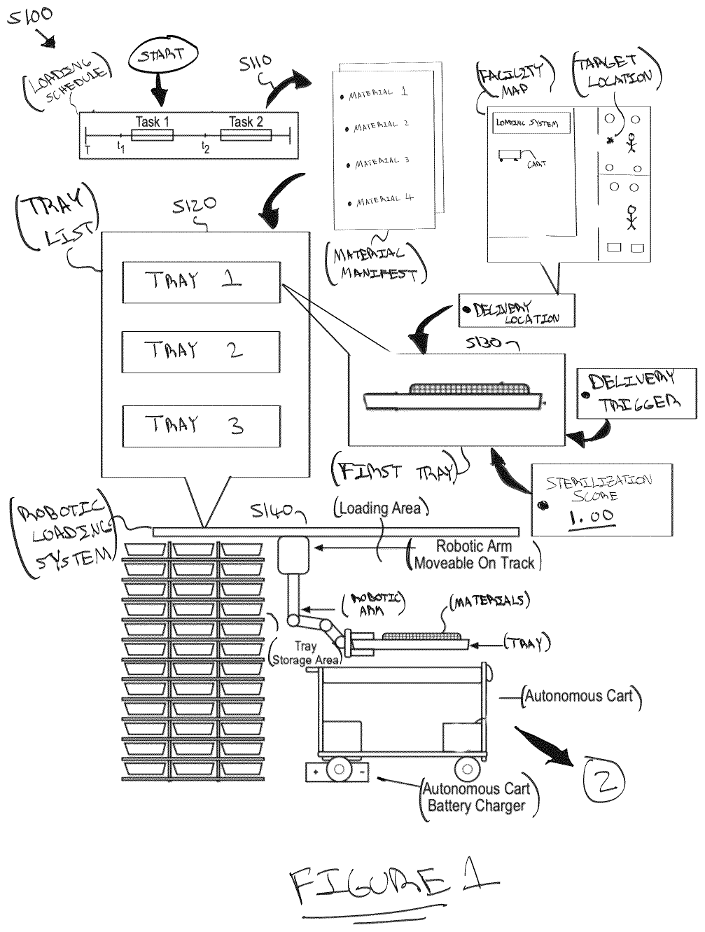

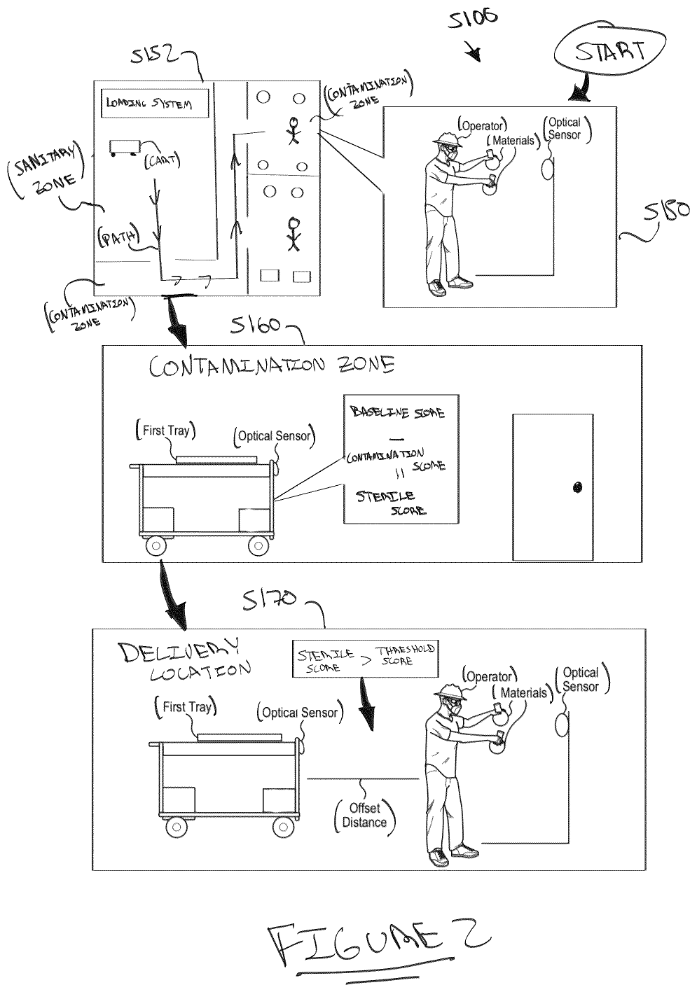

As shown in FIGS. 1 and 2, a method S100 for autonomously delivering materials (e.g., raw materials, equipment units, consumables, parts, kits, product samples, intermediates, finished goods) to operators performing procedures within a facility includes, during a first time period and at a loading system located within at least one sanitary zone (e.g. a classified area with specified level of cleanliness required above a conventional building operating level such as with cleanroom specifications from ISO 14644 or Federal Standard 209E) at the facility, accessing a loading schedule in Block S110 defining: a first manufacturing operation scheduled for execution at a target location within the facility; and a first materials manifest specifying a compliance for the materials to be associated with performance of the first manufacturing operation.

The method S100 further includes, during the first time period, identifying a first compliant materials tray, in a set of trays at the loading system, including a set of compliant materials which have been sterilized corresponding to the first materials manifest for the first manufacturing operation in Block S120. The method S10 also includes, in response to identifying the first compliant materials tray, assigning to the first compliant materials tray in Block S130: a first delivery location proximal the target location within the facility; a first delivery trigger based on the first manufacturing operation; and a baseline material compliance score representing the compliance status, including the sterilization status of the first compliant materials tray.

The material compliance score is a measure of the suitability of a material to be moved into or within a designated zone or area that meet the specifications and requirements for entering into those designated areas for the manufacturing of products. The material compliance score can include a combination of factors including, but not limited to: the sterilization status of the materials being delivered, such as if the materials are sterilized, the sterilization method, the integrity of the sterilization packaging, the sterility testing and validation of the sterilization process for that material in the sterilization load configuration, if the materials are still within the defined time period post-sterilization where they can still be considered sterile, the barcode scan or Optical Character Recognition (OCR) scan from a sensing device for confirming the materials are still in a compliant sterilization state; the sanitization status for the materials such as where the materials were sanitized with a disinfecting cleaner or alcohol (e.g., 70% Isopropyl alcohol) prior to crossing into the sanitary zone within a facility based on the types of materials, the packaging (e.g., such as if the outer layers of packaging are removed prior to entering into a sanitary zone), and the material compatibility when it is sprayed with disinfectants to sanitize; and the cleanliness status of the materials, where the materials are scored based on the packaging, the cleanliness of how the materials were manufactured (e.g., such as the cleanliness specifications they were manufactured in), how they were packaged, the conditions for how the materials were stored, and the length of time the materials were stored for.

The materials compliance score can also include: the potential for contamination status where the material itself can prevent the growth of micro-organisms (bacteria, fungi, mold, viruses, etc.); and the potential for material chemical break down with harmful byproducts, or the potential to harbor micro-organisms, the testing status of the materials (e.g., tested and cleared by Quality Assurance and/or Quality Control) to enter into the manufacturing process. The potential for contamination score can include the potential for contamination, such as a part or component with a high surface area which is unable to be sterilized or sanitized, contains hidden internal pockets such as a computer, contains active components which can spread particulates and micro-organisms around the facility (e.g., a computer cooling fan), made of materials that can increase the risk of micro-organisms (e.g., foam padding or fabrics) and the condition of the materials.

These material status conditions can form a single material compliance score and/or multiple sub-component status scores (sterilization score, sanitization score, cleanliness score, potential for contamination score, etc.) which can be analyzed individually and/or in totality as a combined composite score which can be implemented to confirm if a material can enter into a designated zone or area and/or meets the compliance for execution in the manufacturing operation of a product.

The method S100 also includes triggering a robotic arm at the loading system to load the first compliant materials tray onto an autonomous cart proximal the loading system in Block S40.

The method S100 further includes, during a second time period following the first time period: in response to detecting the delivery trigger, triggering the autonomous cart to maneuver the first compliant materials tray from the sanitary zone to the first delivery location within a contamination zone at the facility in Block S150; accessing a timeseries of locations traversed by the autonomous cart within the contamination zone in Block S152; and calculating a first material compliance score, different from the baseline material compliance score, of the first compliant materials tray based on the timeseries of locations in Block S160.

The method S100 also includes, in response to the first material compliance score exceeding a threshold material compliance status score, triggering the autonomous cart to maintain a target offset distance from the first operator scheduled to perform the first manufacturing operation in Block S170.

The facility can include multiple sanitary zones defined by different specification requirements requiring different material compliance scoring to move from one zone into another, such as different classifications of cleanroom environments, particularly moving from a Grade D zone into a Grade A zone based on the cGMP cleanroom grades, or from an ISO 8 facility into an ISO 5 based on the ISO 14644-1 requirements, or from a Class 100,000 zone to a Class 100 zone based on the outdated FED-STD-209E standard.

Additionally materials can be moved from a higher material compliance specification requirement zones to a lower material compliance specification requirement zone where the compliance specification scoring would allow the materials to move from one zone into another zone and receive a reduction in the material compliance score for each zone that it passes such that the materials are unauthorized to return into a higher material compliance specification zone unless sanitized or sterilized to increase the material compliance scoring to re-enter a higher material compliance zone. For example, intermediate product samples can move from a cleanroom environment to undergo testing in a laboratory, but the materials (flasks, containers, etc.) are then unauthorized to enter the cleanroom areas until the materials are sanitized and/or sterilized to achieve authorization for the higher material compliance scoring to re-enter into those areas.

### 2. Definitions

Generally, “sanitary zone” as referred to herein is a designated zone within a manufacturing facility defined by a specified level of cleanliness required above a conventional building operating level which contains compliant materials for executing manufacturing operations within the manufacturing facility.

Generally, “compliant materials” as referred to herein are materials (e.g., raw materials, equipment units, consumables, parts, kits, product samples, intermediates, finished goods) authorized (e.g., sanitized) for execution in a manufacturing operation within the facility.

Generally, “materials compliance score” as referred to herein is a measure of the suitability of a material to be moved into or within a designated zone or area that meet the specifications and requirements for entering into those designated areas for the manufacturing of products (e.g., pharmaceutical products).

### 3. Applications

Generally, a computer system, a robotic loading system, and an autonomous cart can cooperate to execute Blocks of the method S100 in order to support an operator performing steps of a procedure for production of pharmacological materials within a manufacturing facility. In particular, the autonomous cart can execute Blocks of the method S100 to: access a loading schedule—generated by the computer system—assigned to an autonomous cart defining materials (e.g., raw materials, equipment units, consumables, parts, kits, product samples, intermediates, finished goods) needed for procedures scheduled for performance throughout the facility; trigger loading of these materials to a platform on the autonomous cart; and autonomously deliver these materials to particular operators performing these procedures throughout the facility.

More specifically, the computer system can access a digital procedure that contains a sequence of blocks, wherein some or all of these blocks contain: a particular location within the manufacturing facility of an operator completing specified tasks; a set of compliant materials associated with these specified tasks handled by the operator and necessary to complete these specified tasks; and a target offset distance between the autonomous cart and the operator maintainable throughout completion of the specified tasks by the operator. The computer system can then generate a loading schedule associated with the manufacturing procedure based on the set of compliant materials and an estimated time of completion for performing these specified tasks defined in the digital procedure.

Furthermore, a robotic loading system within the facility can: receive the loading schedule from the computer system; and autonomously load materials specified in the loading schedule onto the autonomous cart, such as by a robotic arm retrieving a tray containing these materials and loading the tray onto the autonomous cart.

The autonomous cart can then navigate to a particular location within the manufacturing facility associated with the materials and achieve a target offset distance to the operator at the particular location, thereby delivering materials (e.g., a network device, guidance equipment, raw materials, consumables, test or measurement equipment, AR/VR/Mixed Reality headsets, or mobile devices) to support the operator throughout completion of specified tasks.

In one example, the autonomous cart can, prior to initialization of a manufacturing procedure by an operator (e.g., non-operation hours of the facility, beginning of the week): generate a loading schedule defining sets of materials associated with specified tasks scheduled for performance throughout the facility; transmit this loading schedule, such as to a computer system at a designated loading area within the facility; and serve this loading schedule to an operator at the loading area of the facility to populate a set of trays with materials associated with the specified tasks scheduled for performance. The autonomous cart can then: identify a first compliant materials tray, in the set of trays, containing a set of compliant materials designated for a first task; trigger loading (e.g., autonomous loading by a robotic arm at the loading area) of the first compliant materials tray to a platform on the autonomous cart; and autonomously maneuver the autonomous cart proximal the operator at the particular location within the facility to deliver the first compliant materials tray containing the set of compliant materials for the first task of the manufacturing procedure.

In the aforementioned example, the autonomous cart can deploy the autonomous cart containing the first compliant materials tray at a target time (e.g., 30 minutes prior to scheduled performance of the first task) at the designated location within the facility. Additionally, in response to confirming removal of the first compliant materials tray from the autonomous cart, the autonomous cart can: autonomously maneuver to the loading area within the facility to trigger loading of a second tray containing a second set of compliant materials for the next task scheduled for performance within the facility; and trigger deployment of the autonomous cart containing the second tray to the operator prior to initialization of the next task in the manufacturing procedure.

Therefore, the autonomous cart can autonomously deliver materials to operators performing specified tasks within the facility in order to reduce time spent collecting materials for performing the manufacturing procedure.

Furthermore, the autonomous cart can execute Blocks of the method S100 to: identify a step deviation of a current task—performed by the operator within the facility—from a target step for the first task defined in the digital procedure; and generate a prompt for the operator to select supplemental materials in response to identifying this step deviation.

For example, the autonomous cart can: track time durations of tasks of the manufacturing procedure performed by the operator; and identify a current time duration for the first task exceeding a target time duration. In this example, the operator performing the first task can be unfamiliar with this first task and require additional guidance to complete the first task. Thus, the autonomous cart can: generate a prompt for the operator to select supplemental materials (e.g., an AR/VR/Mixed Reality headset, AR tablet, a duplicate set of compliant materials to perform the first task again) related to completion of the first task; and serve this prompt to the operator, such as via a display at the autonomous cart and/or an operator device associated with the operator. Additionally, the autonomous cart can: receive selection of supplemental materials by the operator; and maneuver the autonomous cart to the loading area within the facility to retrieve the supplemental materials for the operator.

Therefore, the autonomous cart can receive a request for supplemental materials during performance of manufacturing procedures within a facility and deliver these supplemental materials to the operator “ad-hoc” (or “as needed”) thereby eliminating the need for the operator to traverse the facility to retrieve supplemental materials.

### 3.1 Applications: Material Compliance Tracking

Generally, a computer system, a robotic loading system, and an autonomous cart can cooperate to execute Blocks of the method S100 in order to deliver compliant materials to an operator assigned to perform steps of a procedure within a manufacturing facility (e.g., a pharmacological manufacturing facility with cleanroom areas and/or zones). In particular, the autonomous cart can: execute Blocks of the method S100 to: receive loading—at the robotic loading system—of a set of compliant materials (e.g., consumables, flasks, equipment units, parts, raw materials) required for execution of a procedure within the facility by an operator; maneuver the autonomous cart across a timeseries of locations within the facility; and track a material compliance condition for the set of compliant materials loaded onto the autonomous cart prior to delivering the set of compliant materials to the operator assigned to execute the procedure. Thus, the autonomous cart can: eliminate a requirement of the operator—carrying potential contaminants (e.g., dust, hazardous materials)—to enter a sanitary zone within the facility to retrieve the set of compliant materials; enable delivery of the set of compliant materials for the procedure prior to a scheduled time for executing the procedure; and maintain a material compliance condition for the set of compliant materials above the required material compliance threshold for entering into a defined sanitary zone when delivering the set of compliant materials to the operator.

In particular the autonomous cart can: access a facility map (e.g., three-dimensional map)—representing the facility—specifying a sanitary zone and a contamination zone within the facility; and maneuver proximal the robotic loading system arranged within the sanitary zone within the facility. In a pharmaceutical manufacturing environment, compliant materials required for execution of procedures are located within a designated sanitary zone and risk contamination exposure when removed from the sanitary zone into a contamination zone at the facility. Thus, the autonomous cart can: calculate a path across a sequence of locations within the facility map to maneuver the set of compliant materials—arranged on the autonomous cart—to a delivery location within a contamination zone at the facility; serve the path to the autonomous cart; trigger the autonomous cart to maneuver to the delivery location according to the path; and track the material compliant condition for the set of compliant materials arranged on the autonomous cart prior to delivery to an operator at the delivery location.

In one example, the autonomous cart can: receive loading of the set of compliant materials which were sterilized—from the robotic loading system within the sanitary zone—characterized by a baseline material compliance score representing a maximum sterilized condition for the set of sterilized materials; and identify a first location, in the timeseries of locations, traversed by the autonomous cart in the facility as corresponding to a particular region in the contamination zone characterized by a contamination exposure score. In this example, the autonomous cart can then: calculate a material compliance score for the set of compliant materials loaded on the autonomous cart based on a combination of the first contamination exposure and the baseline material compliance score assigned to the set of compliant materials; and, in response to the material compliance score exceeding a material compliance threshold, triggering the autonomous cart to maneuver proximal the operator at the target location to deliver the set of compliant materials to the operator scheduled to perform the procedure.

Alternatively, in response to the material compliance score falling below the material compliance threshold, the autonomous cart can: flag the materials as non-compliant for execution within the manufacturing operation and therefore disqualified from entering into the sanitary zone and for the execution of the manufacturing operation by the operator—handling the materials—at the target location; trigger the autonomous cart to maneuver proximal the robotic loading system within the sanitary zone in order to receive a replacement set of compliant materials which meets or exceeds the material compliance scoring for the successful execution of the manufacturing operation; and trigger the autonomous cart to maneuver proximal the operator at the target location to deliver the replacement set of compliant materials to enable the operator to complete the scheduled manufacturing operation.

Therefore, the autonomous cart can: track a material compliance condition of a set of compliant materials arranged on an autonomous cart maneuvering throughout the facility; generate an audit trail of potential contamination events for the set of materials within the facility; and trigger delivery of the set of compliant materials that meet the scoring specification requirements to an operator within the facility in response to the material compliance condition of the set of compliant materials exceeding a threshold condition.

### 4. Autonomous Cart

An autonomous cart can execute Blocks of the method S100 for autonomously delivering a set of compliant materials to operators performing steps of a manufacturing procedure within the facility. In particular the autonomous cart can define a network-enabled mobile robot that can autonomously traverse a facility, capture live video feeds of operators within the facility, and deliver a set of compliant materials to operators performing manufacturing procedures throughout the facility.

In one implementation, the autonomous cart includes: a base, a drive system (e.g., a pair of two driven wheels and two swiveling casters); a platform supported on the base and configured to transport materials (e.g., raw materials, consumables, equipment units, parts, and supplies loaded within a tray) associated with procedures performed within the facility; a set of mapping sensors (e.g., scanning LIDAR systems); a geospatial position sensor (e.g., a GPS sensor); or a sensor fusion of the various tracking technologies as outlines in U.S. patent application Ser. No. 16/425,782, which is hereby incorporated in its entirety by this reference. In this implementation, the autonomous cart can further include an optical sensor (e.g., visible light camera, infrared depth camera, thermal imaging camera) defining a line-of-sight for the autonomous cart and configured to capture a live video feed within line-of-sight of the autonomous cart. Additionally, the autonomous cart includes a network device configured to support a network connection to devices within the facility proximal the autonomous cart.

Furthermore, the autonomous cart includes a controller configured to access a digital procedure for the facility containing a first manufacturing operation including a first step defining: a first location within the facility; a supply trigger associated with a set of compliant materials for an operator performing the first step at the first location; a target offset distance between the autonomous cart and the operator proximal the first location; a target offset distance between the autonomous cart and the operator; and a target position and a target orientation of the autonomous cart relative the first location. The controller can then trigger the drive system to navigate the autonomous cart to a position within the facility proximal the first location defined in the first step of the first manufacturing operation.

Additionally, the controller can initiate a first scan cycle and, during the first scan cycle: access a video feed from the optical sensor; extract a set of visual features from the video feed; detect a set of objects—the set of objects including the operator—based on the set of visual features; and trigger the drive system to maneuver the autonomous cart to the operator at the target offset distance to deliver the set of compliant materials loaded on the autonomous cart to the operator. Subsequently, the controller can further initiate a second manufacturing operation in the digital procedure in response to completion of the first manufacturing operation.

### 5. Robotic Loading System

Generally, a robotic loading system includes a robotic arm mounted at a loading area within the facility and a controller configured to: receive a loading instruction, such as from the computer system, from the autonomous cart, and/or from an operator interfacing with a display of the robotic loading system; retrieve materials from a set of compliant materials stored at the loading area and specified in the loading instruction; and autonomously load these materials onto an autonomous cart proximal the robotic arm, such as by retrieving a tray from a set of trays containing the materials.

In one implementation, the autonomous cart can: autonomously navigate to the loading area within the facility; and couple a charging station (e.g., inductive charging station, charging connector) at a particular loading location within the loading area to receive materials. In this implementation, the robotic loading system can then: receive a cart loading schedule—generated by the computer system—specifying a first group of materials; query a list of trays pre-loaded with materials at the loading area within the facility for the first group of materials; in response to identifying a first compliant materials tray, in list of trays, containing the first group of materials, retrieve the first compliant materials tray via the robotic arm; and load the first compliant materials tray onto a platform of the autonomous cart.

### 6. Generating Loading Schedule

Blocks of the method S100 recite, at a robotic loading system located within a sanitary zone at the facility, accessing a loading schedule in Block S110 defining: a first manufacturing operation scheduled for execution at a target location within the facility; and a first materials manifest specifying compliant materials associated with performance of the first manufacturing operation. Generally, the robotic loading system can: access a manufacturing operation schedule representing scheduled procedures for execution within the facility; extract identities for materials required to perform these procedures from the manufacturing operation schedule; and aggregate the identities for materials and scheduled times for the procedures into a loading schedule in order to load the materials required for the procedure onto an autonomous cart prior to scheduled execution of the procedure.

In one implementation, the computer system can access a procedure (e.g., digital procedure) scheduled for performance by an operator within the facility and including a set of steps for performing the procedure. Each block in the set of steps can include: a particular instruction for performing the procedure; an estimated duration of time for performing the particular instruction; a particular operator associated with performance of the particular instruction; a particular location within the facility associated with performance of the particular instruction; and a particular set of compliant materials associated with performance of the particular instruction. The computer system can then generate the loading schedule for autonomous carts operating within the facility based on sets of materials for performing tasks in the procedure and estimated time durations for performing these tasks extracted from the procedure.

In this implementation, the computer system can: transmit the generated loading schedule to a computer system at the loading area within the facility; assign a set of labels—corresponding to steps for performing the procedure—to a set of trays at the loading area within the facility; generate a prompt to populate the labeled set of trays with sets of materials defined in the loading schedule to assemble a set of pre-loaded trays for performing the procedure; and serve this prompt to a loading operator at the loading area within the facility.

In one example, the computer system can access a digital procedure including a first manufacturing operation and a second manufacturing operation. The first step block includes: a first task corresponding to combining a first material and a second material to produce a third material; a first operator performing the first task at a first location within the facility; a first estimated time duration for performing the first task; and a first set of compliant materials including the first material and the second material of the first task. The second manufacturing operation includes a second task corresponding to weighing the third material produced by the first task; a second estimated time duration for performing the second task; and a second set of compliant materials including a scale (e.g., a digital scale) for weighing the third material.

Thus, the computer system can generate a loading schedule including: the first task spanning the first estimated time duration (e.g., 30 minutes); and the second task spanning the second estimated time duration (e.g., 10 minutes) and succeeding the first task in the loading schedule. The computer system can then: transmit this generated loading schedule to a computer system at a loading area within the facility; generate a first label for a first compliant materials tray which have been sterilized at the loading area corresponding to the first set of compliant materials for performing the first task; and generate a second label for a second tray at the loading area corresponding to the second set of compliant materials which have been sterilized for performing the second task. A loading operator at the loading area within the facility can then assemble the first tray to include the first set of compliant materials which have been sterilized and the second tray to include the second set of compliant materials which have been sterilized.

Therefore, the computer system can generate the loading schedule to assemble a set of trays containing materials necessary for performing procedures at the facility prior to performance of these procedures within the facility in order to readily deliver these trays to operators performing the procedures at scheduled time windows.

### 7. Tray Loading

Blocks of the method S100 recite, identifying a first compliant materials tray, in a set of trays at the loading system, comprising a set of compliant materials corresponding to the first materials manifest for the first manufacturing operation in Block S120. The method S100 also recites, in response to identifying the first compliant materials tray, assigning the first compliant materials tray, in Block S130: a first delivery location proximal the target location within the facility; a first delivery trigger based on the first manufacturing operation; and a baseline materials compliance score representing a compliance status of the first compliant materials tray. The method S100 further recites triggering a robotic arm at the loading system to load the first compliant materials tray onto an autonomous cart proximal the loading system in Block S140.

Generally, the robotic loading system can: locate a set of compliant materials at the robotic loading system corresponding to a next scheduled manufacturing operation in the facility; and load the set of compliant materials onto an autonomous cart proximal the robotic loading system. More specifically, the computer system can: access a target location of a first compliant materials tray at the robotic loading system containing the set of compliant materials required for execution of the manufacturing operation; maneuver a robotic arm to maneuver proximal the target location of the first compliant materials tray at the robotic loading system; trigger an end effector arranged at the robotic arm to retrieve the first compliant materials tray; and trigger the robotic arm to load the first compliant materials tray onto the autonomous cart.

In one implementation, the autonomous cart can: access a loading schedule assigned to an autonomous cart defining materials (e.g., raw materials, equipment units, consumables) needed for procedures scheduled for performance throughout the facility; and trigger the drive system to autonomously maneuver the autonomous cart to a loading area within the facility. At the loading area, the robotic loading system can then: query a tray list representing a set of pre-loaded trays containing materials for performing procedures within the facility at the loading area within the facility; identify a first compliant materials tray—in the tray list—containing the set of compliant materials from the first manufacturing operation; and trigger loading of the first compliant materials tray—in the set of trays at the loading area—to the platform of the autonomous cart. The autonomous cart can then, prior to initiation of the first manufacturing operation by the operator within the facility, autonomously deploy the autonomous cart from the loading area to a target location within the facility proximal the operator to deliver the first compliant materials tray containing the set of compliant materials.

In one example, the robotic loading system can receive a loading schedule assigned to the autonomous cart, such as by a computer system managing a set of autonomous carts within the facility. The loading schedule can include a set of tasks for procedures scheduled for performance in the facility over a planned time period (e.g., a day, a week) and assigned to the autonomous cart. Each task in the set of tasks can include: a particular instruction for the procedure scheduled for performance within the facility; an identifier for a particular operator assigned to performance of the particular instruction within the facility; a particular location within the facility assigned to the particular operator for performance of the particular instruction; a risk level associated with performance of the particular instruction; and a particular set of compliant materials pertinent to performance of the particular instruction by the particular operator at the particular location within the facility.

The robotic loading system can then: identify a first set of compliant materials associated with performance of a first task of the procedure by an operator within the facility in the loading schedule; and identify absence of the first set of compliant materials on the autonomous cart, such as by detecting absence of objects via a weight sensor at the autonomous cart, detecting absence of objects via a camera at the loading area and directed to the autonomous cart, and/or identifying absence of objects in a materials log associated with the autonomous cart. The autonomous cart can then trigger the drive system to autonomously maneuver the autonomous cart to a loading area within the facility in response to identifying absence of the set of compliant materials on the autonomous cart.

In the aforementioned example, the autonomous cart can: maneuver proximal a particular loading location within the loading area of the facility; and couple a charging station (e.g., an inductive charging plate, charging connector) configured to charge a battery of the autonomous cart during loading of materials.

At the loading station the robotic loading system can: access a tray list defining a set of trays (e.g., pre-loaded to contain a particular set of compliant materials for performing a particular task); query the tray list to identify a first compliant materials tray corresponding to a first task scheduled for performance within the facility; and, in response to identifying the first compliant materials tray in the tray list, trigger loading of the first compliant materials tray from the loading area to the autonomous cart, such as manually by a loading operator at the loading area and/or autonomously by the robotic arm at the loading area.

At the loading station the robotic loading system can load more than one tray to a cart at a time. The position of each tray is noted in the system to inform the operator receiving a cart with multiple trays loaded onto it, which tray with the correct items for executing the steps in the procedure the operator needs to execute at that time. The cart can be loaded with trays containing the items the next series of steps for the same procedure or they can be loaded with trays containing the items for the steps for multiple different procedures being executed in the same area, even if they are executed by different operators.

Alternatively, in response to identifying absence of the first compliant materials tray in the tray list, the robotic loading system can generate: a prompt to assemble a tray containing the particular set of compliant materials associated with performance of the first task of the procedure; and serve this prompt to a loading operator portal at the loading area.

Therefore, the autonomous cart can: confirm presence of a first compliant materials tray containing a first set of compliant materials associated with performing a first scheduled task within the facility at the autonomous cart; and autonomously deploy the autonomous cart to a particular location within the facility proximal a first operator performing the first scheduled task to deliver the first compliant tray to the operator.

### 7.1 Compliant Material Loading

Blocks of the method S100 further recite: at the first loading time, triggering the loading system to retrieve a first compliant material specified in the first materials manifest from the loading schedule in Block S112; triggering the loading system to load the first compliant material onto a first compliant materials tray within the sanitary zone at the facility in Block S114; generating a first materials tag, in a materials library, defining a first identity for the first compliant material loaded onto the first compliant materials tray in Block S116; and triggering the loading system to load the first compliant materials tray into a shelf containing a set of trays within the sanitary zone at the facility.

Generally, the robotic loading system can: access a manufacturing operation schedule representing manufacturing operations scheduled for execution within the facility; identify a manufacturing operation, in the manufacturing operation schedule, scheduled for execution at a target location within the facility by an assigned operator; and aggregate a set of compliant materials required to be handled by the operator in order to complete execution of the manufacturing operation. More specifically, the robotic loading system can: identify a set of compliant materials required by the operator in order to execute the manufacturing operation; aggregate the set of compliant materials at the robotic loading system arranged at a sanitary zone within the facility; and, prior to the scheduled time of the manufacturing operation, load the set of compliant materials onto an autonomous cart in order to deliver the set of compliant materials to the assigned operator located in a contamination zone within the facility prior to the scheduled time for the manufacturing operation. Thus, the autonomous cart can trigger delivery of the set of compliant materials to the operator prior to the scheduled time of the manufacturing operation, thereby eliminating the need for the operator to maneuver through the sanitary zone in order to retrieve the required set of compliant materials and mitigate exposure of contaminants—carried by the operator—to compliant materials in the sanitary zone.

In one implementation, the robotic loading system can: access a manufacturing operation schedule representing manufacturing operations scheduled for execution within the facility; and identify a manufacturing operation, in the manufacturing operation schedule, scheduled for execution during a scheduled time window (e.g., thirty minutes, one hour, three hours) by an assigned operator; extract identities of a sequence of materials specified in a first step of the manufacturing operation; and identify a group of materials, in the sequence of materials, as corresponding to compliant materials required for execution of the manufacturing operation. For example, the robotic loading system can identify, in the sequence of materials: consumable materials in a compliant condition for execution of the manufacturing operation; flasks and/or tubes in a sterilized condition that contact the consumable materials during execution of the manufacturing operation; and/or equipment units (e.g., centrifuges, mixers) in a sanitized condition handled by the operator during execution of the manufacturing operation.

Additionally, the robotic loading system can then: generate a materials manifest representing the group of materials for loading onto an autonomous cart prior to the scheduled time for executing the first step; and assign a loading time for the compliant materials in the materials manifest based on the scheduled time window for the manufacturing operation. For example, the robotic loading system can: access a manufacturing operation schedule representing manufacturing operations scheduled for execution within the facility; identify a manufacturing operation, in the manufacturing operation schedule, scheduled for execution between 11:00 AM and 2:00 PM for a current day in the facility by an assigned operator; and assign the first loading time for the compliant materials in the materials manifest at 9:00 AM of the current day prior to scheduled execution of the manufacturing operation. Accordingly, the robotic loading system can then: aggregate the manufacturing operation, the materials manifest, and the loading time for the compliant materials, into a loading schedule; and store the loading schedule, such as in a database at the robotic loading system.

Additionally or alternatively, the robotic loading system can repeat the steps described above for a set of manufacturing operations scheduled for execution in the facility across a target duration of time (e.g., daily, weekly, monthly) in order to generate a loading schedule corresponding to the set of manufacturing operations scheduled at the facility.

Therefore, the robotic loading system can: routinely (e.g., daily) retrieve the loading schedule from the database; and load autonomously compliant materials onto an autonomous cart proximal the robotic loading system for delivery to operators within the facility performing manufacturing operations.

In one implementation, the robotic loading system can: at the loading time, retrieve each material specified in a materials manifest for a manufacturing operation specified in the loading schedule; and aggregate each material specified in the materials manifest into a first compliant materials tray located within the sanitary zone at the facility. For example, the robotic loading system: generate a prompt requesting a local operator within the sanitary zone to retrieve each material in the materials manifest; and serve this prompt to an operator device associated with the operator; and receive loading (e.g., via robotic arm) of each material, in the materials manifest, onto the first compliant materials tray in the sanitary zone.

In another example, the robotic loading system can: access a live video feed from an optical sensor arranged within the sanitary zone and defining a field of view of a corpus of compliant materials in the sanitary zone; implement computer vision techniques, such as described in U.S. Non-Provisional application Ser. No. 17/968,684, filed on 18 Oct. 2022, which is hereby incorporated in its entirety by this reference, to identify a set of compliant materials—in the corpus of materials—corresponding to the materials manifest; trigger a robotic arm to autonomously retrieve the set of compliant materials; and autonomously load the set of compliant materials onto a compliant materials tray within the sanitary zone. Accordingly, the robotic loading system can then: generate a materials tag, in a materials library, representing identities for each material specified in the materials manifest for the manufacturing operation; and load (e.g., via a robotic arm) the compliant materials tray onto a shelf containing a set of trays within the sanitary zone at the facility. The compliant materials which undergo sterilization can receive a barcode and/or sticker specifying the sterilization date and the sterilization expiration date for the materials that were sterilized. The compliant materials can be tracked by the Manufacturing Execution Systems (MES) for generating a physical materials tag in the materials library, informing the robotic loading system when the material is scanned from an optical sensor through the barcode scan and/or Optical Character Recognition (OCR) processing for an attached label to confirm that the sterilization status meets the minimal material compliance scoring for loading onto the tray for the execution of the scheduled process in the required sanitary zone.

In alternate embodiments the trays themselves can contain an enclosure which can enclose or envelope the materials, contents, and/or components inside, where the entire tray is sterilized, the tray receives a material compliance scoring by the system and can implement barcodes, visual markers, sterilization stickers, RFID tags, or other electronic tags to generate a materials tag which links the sterilization record to the physical tag present on the sterilized tray by the system, the complaint sterilized tray is scanned by the optical sensor system and in response to the materials achieving a target material compliance score, the materials are loaded onto an autonomous cart via the robotic loading system. The autonomous cart can then autonomously navigate to the scheduled delivery area in the sanitary zone and trigger the tray enclosure to open in response to delivery at the location and detecting the operator present to execute the required tasks handling the compliant materials. Once the sterilized tray enclosure is opened the material compliance scoring is decreased so the opened sterilized tray can no longer be moved to a sanitary zone with higher requirements or specifications and can only be moved to zones of the facility with lower requirements.

In another example, at the loading time, the robotic loading system can: access a materials library representing a set of trays arranged on a shelf proximal the robotic loading system within the sanitary zone; and identify a materials tag—corresponding to a first compliant materials tray arranged at a target location on the shelf—in the materials library representing the materials manifest for the manufacturing operation scheduled for execution in the facility. Accordingly, the robotic loading system can then: trigger the robotic arm to maneuver an end effector (e.g., gripper) proximal the target location at the shelf containing the set of trays; and trigger the end effector to grasp the first compliant materials tray from the shelf; and load the first compliant materials onto to the autonomous cart proximal the robotic loading system.

Therefore, the robotic loading system can: load compliant materials required for execution of a scheduled manufacturing operation within the facility onto an autonomous cart; and deliver the compliant materials to an operator scheduled to perform the manufacturing operation without requiring the operator to enter the sanitary zone within the facility.

### 7.2 Loading Times

In one implementation, the robotic loading system can: access a loading schedule defining a scheduled time window (e.g., between 11:00 AM and 2:00 PM) for a manufacturing operation within the facility; assign the delivery trigger for a set of compliant materials corresponding to the manufacturing operation at a first target time (e.g., 10:00 AM) prior to the scheduled time window for the manufacturing operation; and assign a loading time for the set of compliant materials at the robotic loading system at a second target time prior to the first target time (e.g., 9:00 AM). Accordingly, the robotic loading system can then: at the second target time, trigger loading of the set of compliant materials onto the autonomous cart proximal the robotic loading system at the sanitary zone within the facility; and at the first target time, trigger the autonomous cart to maneuver the set of compliant materials to the delivery location within the facility to deliver the compliant materials to an operator prior to scheduled execution of the manufacturing operation. Thus, the robotic loading system can: repeat steps described above across multiple manufacturing operations specified in the loading schedule to autonomously load compliant materials across a set of autonomous carts; and deploy the set of autonomous carts to deliver the compliant materials to operators prior to a scheduled time for executing the manufacturing operations.

### 8. Autonomous Cart Delivery

Blocks of the method S100 recite: in response to detecting the delivery trigger, triggering the autonomous cart to maneuver the first compliant materials tray from the sanitary zone to the first delivery location within a contamination zone at the facility in Block S150; accessing a timeseries of locations traversed by the autonomous cart within the contamination zone in Block S152; calculating a first compliant materials score, different from the baseline compliant materials score, of the first compliant materials tray based on the timeseries of locations in Block S160; and, in response to the first compliant materials score exceeding a threshold compliant materials score, triggering the autonomous cart to maintain a target offset distance from a the first operator scheduled to perform the first manufacturing operation in Block S170.

Generally, the autonomous cart and the computer system can cooperate to autonomously deploy the autonomous cart—containing the set of compliant materials associated with performance of a procedure—to an operator at a first time prior to scheduled performance of the procedure within the facility. In particular the autonomous cart can, at a target time, deliver a first material to a first location proximal an operator performing a procedure, such as by tracking locations of the operator performing tasks of the procedure via a suite of sensors (e.g., GPS, optical sensors) at the autonomous cart and/or interfacing with the computer system to monitor a current step of the procedure performed by the operator. The autonomous cart can: detect a trigger condition for a second set of compliant materials associated with a next step in the digital procedure; autonomously navigate the autonomous cart to a delivery location associated with the second set of compliant materials; and maintain a minimum offset distance from the operator once the second set of compliant materials have been removed from the autonomous cart.

In one implementation, prior to initialization of a digital procedure by an operator at a scheduled time period within the facility, the autonomous cart can: trigger loading a first compliant materials tray containing a first set of compliant materials associated with performance of a first task in the digital procedure; and confirm presence of the first compliant materials tray loaded on a platform of the autonomous cart, such as via a weight sensor at the autonomous cart and/or a camera at the autonomous cart and/or receiving manual confirmation of the loaded tray; and at a target time period (e.g., 10 minutes) prior to the scheduled time period for the digital procedure, maneuver the autonomous cart to a target location within the facility proximal the operator performing the first task.

Upon delivery of the autonomous cart to the target location within the facility, the autonomous cart can: generate a prompt instructing the operator to retrieve the first compliant materials tray from the autonomous cart; serve this prompt to the operator, such as via a display at the autonomous cart and/or to an external device (e.g., AR/VR/Mixed reality headset, tablet, or other mobile device) associated with the operator; and receive confirmation—from the operator—that the delivered first compliant materials tray contains the first set of compliant materials for performing the first task in the procedure. Thus, the autonomous cart can deliver the first compliant materials tray to the operator at a target time window, thereby allowing the operator to initialize the first task in the digital procedure at the scheduled time period without having to manually retrieve the set of compliant materials for performing the first task.

The autonomous cart can also trigger the completion of the delivery: when the operator removes the tray from the cart (optical and/or magnetic sensor); removes the contents of the tray from the cart (weight sensor); manually inputs that the content has been removed at the autonomous cart; finishes or completes the measurement testing on a piece of equipment on the cart; and/operator receives AI input into the system that the step has been completed. This will release the cart from the operator and send it back to the robotic loading system to receive the contents for the next process.

In an alternate implementation, shown in FIG. 2, more than one tray containing items for the execution of multiple steps can be available on the cart for the operator to select from. The system can inform the operator on which tray to select from based on the position and placement of the tray onto the cart by the robotic loading station. The trays can contain an identification number, QR Code, visual marker, Bluetooth beacon, and/or other methods for the operator to positively identify and/or scan the tray to confirm it is the correct tray and materials to use for the execution of the next step. In alternate embodiments, shown in FIG. 2, the trays can contain a display device like an LCD screen, electronic ink, or other display type that is linked to the system and confirm the purpose of the step. In still alternate embodiments, shown in FIG. 2, the tray contains an augmented display that informs the operator wearing an Augmented Reality headset and/or an Augmented Reality mobile device which tray and items inside of the tray to use for the next step. This Augmented Reality display can be a volumetric display that informs the operator which tray and item to use and which tray and items not to use for the execution of the next step. If the incorrect item is picked up by the operator the system can provide an audio and/or visual display informing the operator they have selected the incorrect component and they need to select the correct component before being able to procedure further with the step execution.

### 8.1 Autonomous Cart Support During Task Performance

In one implementation, the autonomous cart can include: a wireless signal extender (e.g., router, network device) configured to extend a wireless communication range of operator devices associated with operators within the facility; and a set of safety materials (e.g., first aid, fire extinguisher) loaded at the autonomous cart. In this implementation, in response to initialization of the digital procedure by the operator, the autonomous cart can maintain a target offset distance between the operator and the autonomous cart during performance of the first task in the procedure to support the operator to: maintain a target wireless signal strength for an operator device during performance of the first task in the procedure; and/or approach the operator to deliver the set of safety materials in response to interpreting an emergency event during performance of the first task of the procedure.

In this implementation, the autonomous cart can then maneuver the autonomous cart to return to the loading area within the facility in response to conclusion of performance of the first task in the procedure by the operator.

In another implementation, the robotic loading system can: assign a delivery trigger specifying an equipment unit of a target equipment type associated with the manufacturing operation scheduled for execution within the facility; and detect the delivery trigger at the target location by interpreting presence of the operator scheduled to perform the manufacturing operation proximal the equipment unit of the target equipment type at the delivery location. In particular, the robotic loading system can: access a live video feed from an optical sensor (e.g., tablet, camera) defining a field of view of a workspace proximal the operator at the target location; extract a set of visual features from the live video feed; and implement computer vision techniques to interpret presence of the operator proximal the equipment unit of the target equipment type based on the set of visual features. Thus, the robotic loading system can: detect the delivery trigger in response to interpreting presence of the operator at the equipment unit of the target equipment type; and trigger the autonomous cart to maneuver from the sanitary zone proximal the robotic loading system to the delivery location within the facility in order to deliver compliant materials to the operator executing the manufacturing operation.

### 8.2 Next Task in Procedure

In one implementation, the autonomous cart can: autonomously maneuver to the loading area within the facility in response to confirming removal of the first compliant materials tray—by the operator—at the target location within the facility; and trigger loading of a second tray containing a second set of compliant materials associated with performance of a second task in the digital procedure by the operator at the target location within the facility. In this implementation, the autonomous cart can: track an estimated time duration for performance of the first task by the operator; and, at a target time window (e.g., 10 minutes) prior to estimated conclusion of the first task, maneuver to the operator at the target location within the facility in order to deliver the second tray to the operator.

Therefore, the autonomous cart can deliver the second tray of the procedure to the operator prior to conclusion of the first task in the procedure, thereby allowing the operator to readily initialize the second task in the procedure without manually gathering the set of compliant materials for performing the second task.

In another implementation, the autonomous cart can: track an estimated time duration for performance of the first task by the operator; query a list of autonomous carts operating at the facility; identify a second autonomous cart in the list of autonomous carts containing the second tray containing the second set of compliant materials; and, at a target time window (e.g., 10 minutes) prior to estimated conclusion of the first task, trigger the second autonomous cart to maneuver to the target location proximal the operator to deliver the second tray.

### 8.3 Calculating Material Compliance Score

In one implementation, the robotic loading system can: identify a set of compliant materials within the sanitary zone corresponding to a materials manifest for a scheduled manufacturing operation at the facility; assign a baseline material compliance score to the set of compliant materials representing a compliance condition for the set of compliant materials at the sanitary zone; load (e.g., via a robotic arm) the set of compliant materials onto an autonomous cart proximal the robotic loading system; and trigger the autonomous cart to maneuver the set of compliant materials to the delivery location in order to deliver the set of compliant materials to an operator scheduled to execute the manufacturing operation.

In this implementation, the autonomous cart can then: maneuver across a timeseries of locations within a sanitary zone of the facility to deliver the set of compliant materials to the operator scheduled to execute the manufacturing operation; track a material compliance score of the set of compliant materials across the timeseries of locations traversed by the autonomous cart; and, in response to the material compliance score exceeding the threshold material compliance score, triggering the autonomous cart to maintain a target offset distance from the operator at the delivery location in order to deliver the set of compliant materials to the operator executing the manufacturing operation. Thus, the autonomous cart can maintain awareness of the compliance conditions for the set of compliant materials loaded on the autonomous cart while traversing sanitary zones within the facility to deliver the set of compliant materials to the operator scheduled to execute the manufacturing operation.

In one implementation, the autonomous cart can access a facility map (e.g., three-dimensional depth map) representing the facility and defining: the sanitary zone—representing a designated area for the facility with a specific classification such as ISO 5 zone which would correspond to a Class 100 zone for the older FED STD-209E standards—containing the robotic loading system; and a contamination zone—representing areas of the facility that are designated as non-sterile or conventional building areas—including a set of regions, each defined by a contamination exposure score.

For example, a compliant material such as a filter assembly, which has been sterilized receives a material compliance score (e.g., 100) for the internal material with multiple layers of packaging. The material compliance score for the external packaging is based on which zone of a facility it is sterilized and removed from, such as being sterilized in an ISO 8 facility without a direct passthrough to a higher sanitary zone, from an autoclave or other similar sterilization unit. This compliant material since it is fully sterilized and is designed for operation inside of a cleanroom environment can be transferred and implemented in sanitary zones up to ISO 2 locations but requires the layers of exterior packaging to be removed during transfer across zones.

In this example the compliant material—which is sterilized—is scheduled to be delivered to an ISO 5 sanitary zone which requires a minimum material compliance score (e.g., 80). When the material is transferred from the ISO 8 cleanroom environment the outermost packaging receives a material compliance score for that sanitary zone (e.g., 50). The autonomous cart autonomously moves the compliant material to an ISO 6 intermediatory sanitization zone where the outer portion of the first layer of packaging is removed and the material compliance score matches the zone where the material is removed (e.g., 70). The internal packaging is sanitized with a disinfectant cleaner which updates the material compliance score (e.g., 80) where it is transferred into an ISO 5 sanitary zone (requiring a score of at least 80). Inside the ISO 5 sanitary zone the final packaging layer is removed and the compliant material which has been sterilized with a material compliance score (e.g., 100) is then implemented within the process. The tray—implemented for transferring the material—can be sanitized to bring the compliant materials into the ISO 5 sanitary zone has a material compliance score (e.g., 80) but when the autonomous cart moves into sanitary zones with lower requirements the material compliance score changes to reflect the change (e.g., goes from a material compliance score of 80 to 50 as the contamination risk is subtracts from the scoring). Additionally, factors such as handling of the compliant materials by unauthorized users, getting hazardous materials onto the surface of the compliant materials or the packaging, or compromise of the integrity of the packaging materials can update the material compliance score resulting in that compliant material no longer have sufficient scoring to be allowed to be delivered to that sanitary zone within a facility.

In an alternate example a compliant material, such as a piece of equipment, more specifically a filter integrity testing unit, is scheduled to be transferred into an ISO 7 sanitary zone. The filter integrity tester has an onboard computer, microprocessors, calibrated sensors, and precision actuating valves. Such a piece of equipment cannot be sterilized by placing it into an autoclave where the heat and pressure would destroy the unit or exposed to gamma irradiation which would destroy the sensitive electronics for the unit. The unit has the potential to undergo sterilization via chemical gases such as Vaporized Hydrogen Peroxide (VHP) or Ethylene Oxide (EtO). The unit can instead be sanitized to meet the requirements and the material compliance score to be transferred and implemented in the sanitary zone of the facility. In this example the filter integrity testing equipment unit is returned from the previous process execution which took place in an ISO 8 sanitary zone with a material compliance score (e.g., 50). The filter integrity testing unit is manually sanitized by an operator or an autonomous cleaning robotic unit, receives a new sterilized filter connection kit, and is transferred to the robotic loading system, which transfers the sanitized unit to a compliant tray which has a material compliance score (e.g., 80). The material compliance score (e.g., 80) meets or exceeds the specification to be transferred to the ISO 7 sanitary zone (e.g., 60) allowing for the autonomous cart to deliver the materials to the specified sanitary zone for execution of the scheduled procedure steps.

In an alternate example, the facility map can: define a first region in the contamination zone representing a region of high operator traffic in the facility and assigned a first contamination score (e.g., 40); and/or define a second region in the contamination zone representing a region exposed to hazardous materials and assigned a second contamination score (e.g., 30).

Accordingly, the autonomous cart can: calculate a target path—specifying a timeseries of locations—from the cleanroom and/or sanitary zone within the facility, containing the autonomous cart, to the delivery location within a contamination zone in the facility according to the facility map; serve the target path to the autonomous cart; and maneuver the autonomous cart to the delivery location within the facility according to the target path while avoiding maneuvering into sanitary or contamination zones with lower specifications which will have a negative impact on the material compliance scoring for the compliant materials. Additionally, the autonomous cart can: calculate the material compliance score for the set of compliant materials at the autonomous cart based on the timeseries of locations traversed by the autonomous cart and the baseline material compliance score; and, in response to the material compliance score exceeding a threshold material compliance score, trigger the autonomous cart to maintain a target offset distance from the operator to deliver the set of compliant materials.

In one example, the autonomous cart can: identify a first location in the timeseries of locations corresponding to a first region, in the set of regions, defined by a first contamination exposure score; identify a second location, in the timeseries of locations, corresponding to a second region, in the set of regions, defined by a second contamination score; and calculate the material compliance score based on a combination of the first contamination exposure score, the second contamination exposure score, and the baseline material compliance score assigned to the set of compliant materials. Therefore, the autonomous cart can maintain contextual awareness of a material compliance condition for a set of compliant materials loaded onto the autonomous cart as the autonomous cart traverses the facility to deliver the set of compliant materials to a delivery location.

In another implementation, the autonomous cart can: access an image captured at a first location, in the timeseries of locations, from an optical sensor (e.g., depth sensor, camera) arranged at the autonomous cart and defining a field of view of the compliant materials tray arranged on the autonomous cart; extract a set of visual features from the first image; and implement computer vision techniques (e.g., object recognition) to interpret a contamination event—characterized by a contamination exposure score—associated with the set of compliant materials arranged on the autonomous cart. For example, the autonomous cart can: interpret a contamination event corresponding to unauthorized tampering of the set of compliant materials on the autonomous cart by unauthorized operators within the facility which can compromise the compliant material's packaging; and/or interpret a contamination event corresponding to exposure of the set of compliant materials to a hazardous material (e.g., hazardous spill) on the autonomous cart.

Accordingly, the autonomous cart can then: calculate the material compliance score based on a combination of the contamination exposure score of the contamination event and the baseline material compliance score assigned to the set of compliant materials; and, in response to the material compliance score exceeding a threshold material compliance score, trigger the autonomous cart to maintain a target offset distance from the operator to deliver the set of compliant materials.

In yet another implementation, the autonomous cart can: detect removal of the set of compliant materials from the autonomous cart, such as via a pressure sensor arranged at the autonomous cart and/or an optical sensor at the autonomous cart; and, in response to removal of the set of compliant materials, receive a set of operator credentials from an operator device associated with an operator proximal the autonomous cart. Accordingly, the autonomous cart can then: identify the operator as unauthorized to remove the set of compliant materials from the autonomous cart based on the set of operator credentials; and calculate the material compliance score based on the set of operator credentials and the baseline material compliance score. For example, the autonomous cart can: extract a materials handling score from the set of operator credentials representing an experience level of the operator within the facility (e.g., expert, beginner, intermediate); and calculate the material compliance score based on a combination of the materials handling score and the baseline material compliance score assigned to the set of compliant materials on the autonomous cart.

Therefore, the autonomous cart can: track a material compliance condition of a set of compliant materials arranged on an autonomous cart maneuvering throughout the facility; generate an audit trail of potential contamination events for the set of compliant materials within the facility; and trigger delivery of the set of compliant materials to an operator within the facility in response to the material compliance condition of the set of compliant materials exceeding a threshold condition.

### 8.4 Detecting Contamination

In one implementation, the autonomous cart can: to maneuver the set of compliant materials from the sanitary zone to the delivery location within the contamination zone at the facility; access a timeseries of locations traversed by the autonomous cart within the contamination zone; and, as described above, calculate the material compliance score for the set of compliant materials based on the timeseries of locations and the baseline material compliance score. In this implementation, in response to the material compliance score falling below the threshold material compliance score, the autonomous cart can: flag the set of compliant materials as containing contaminated materials disqualified for the manufacturing operation; and maneuver to the robotic loading system within the sanitary zone within the facility.

The robotic loading system can then: schedule the autonomous cart including the contaminated materials for a sterilization and/or sanitization cycle prior to integration into the facility; and/or trigger a second autonomous cart proximal the robotic loading system to deliver a second set of compliant materials for the manufacturing operation to the operator.

In one example, the autonomous cart can: access an image captured at a target location, in the timeseries of locations, from an optical sensor (e.g., depth sensor, camera) arranged at the autonomous cart and defining a field of view of the set of compliant materials on the autonomous cart; extract a set of visual features from the image; and implement computer vision techniques to interpret a contamination event corresponding to unauthorized retrieval of the set of compliant materials on the autonomous cart. Accordingly, the autonomous cart can then: calculate the material compliance score as falling below the threshold material compliance score; flag the set of compliant materials on the autonomous cart as disqualified for the manufacturing operation; and maneuver the set of contaminated materials to the sanitary zone within the facility.

Therefore, the autonomous cart can: maintain contextual awareness of a material compliance condition for a set of compliant materials loaded onto the autonomous cart; and prevent operators from handling contaminated materials and introducing the contaminated materials into the manufacturing operation.

### 8.5 Maintaining Offset Distance

As described in U.S. Non-Provisional application Ser. No. 18/120,284, filed on 10 Mar. 2023, which is hereby incorporated in its entirety by this reference, the autonomous cart can: detect presence of an operator executing the manufacturing operation at the target location within the facility; and maintain a target offset distance from the operator in order to deliver the set of compliant materials arranged on the autonomous cart to the operator. Accordingly, the autonomous cart can: detect retrieval of the set of compliant materials arranged on the autonomous cart by the operator; maintain the target offset distance during execution of the manufacturing operation by the operator; and, following completion of the manufacturing operation, maneuver proximal the robotic loading system to retrieve a set of compliant materials corresponding to a subsequent manufacturing operation scheduled for execution within the facility.

In one implementation, the autonomous cart can: access the live video feed from an optical sensor (e.g., depth sensor, camera) arranged at the autonomous cart and defining a field of view intersecting the target location within the facility; extract a set of visual features from the live video feed; and implement computer vision techniques to interpret an offset distance between the autonomous cart and the operator at the target location; and, in response to the offset distance deviating from a target offset distance, trigger the autonomous cart to navigate to a location offset from the first operator by the target offset distance.

Accordingly, in response to the autonomous cart occupying the target offset distance, the autonomous cart can: receive a set of operator credentials from an operator device associated with the operator at the target location; authenticate the operator to retrieve the set of compliant materials arranged on the autonomous cart according to the set of operator credentials; generate a prompt requesting the operator to retrieve the set of compliant materials from the autonomous cart; and serve the prompt to a display coupled to the autonomous cart.

Therefore, the autonomous cart can: maintain contextual awareness of the operator executing the manufacturing operation at the target location; detect removal of the set of compliant materials from the autonomous cart; and, following completion of the manufacturing operation, maneuver proximal the robotic loading system to accept loading of compliant materials for a subsequent manufacturing operation scheduled at the facility.

### 9. Ad-Hoc Autonomous Cart Delivery

Generally, the autonomous cart can deliver materials to operators performing tasks of procedures throughout the facility ad-hoc (or “as needed”). In particular the autonomous cart can, in response to receiving a request for materials, deliver a first material—associated with performance of a particular task in a procedure—to a first location within the facility in order to deliver the first material to the operator.

Furthermore, the autonomous cart can identify variations in performance of the procedure, such as by: tracking locations and actions of the operator performing the procedure; correlating operator location and operator action with a current step of the digital procedure; predict material needs for the operator based on a current selection of materials at the autonomous cart; and preemptively navigate the autonomous cart to a delivery location to deliver these materials to the operator. Additionally, the autonomous cart can maintain a target offset distance to the operator during performance of the procedure and predict a next operator location based on steps in the digital procedure and past operator locations in previous instances of the digital procedure.

Alternatively, the autonomous cart can receive a selection indicating that additional materials are not present on the autonomous cart. The autonomous cart can then: autonomously navigate to the loading area within the facility; receive the additional materials from the robotic loading system; and autonomously navigate—while containing the additional materials—to the operator that requested the additional materials.

In one implementation, the robotic loading system can assign the delivery trigger to the set of compliant materials specifying: an operator profile associated with an operator assigned for execution of the manufacturing operation within the facility; and a scheduled time window for the operator to perform the manufacturing operation. Accordingly, the robotic loading system can then: at a first time, receive a delivery request—characterized by a set of operator credentials representing the operator—from an operator device at the target location for executing the manufacturing operation; detect the delivery trigger by identifying the set of operator credentials as corresponding to the operator profile specified in the delivery trigger; and, in response to the first time falling within the scheduled time window, trigger the autonomous cart to maneuver the set of compliant materials from the sanitary zone to the delivery location. Thus, the robotic loading system enables an operator—scheduled to perform a manufacturing operation—to remotely request delivery of compliant materials prior to the scheduled time for executing the manufacturing operation.

### 9.1 Operator Requested Materials

In one implementation, the autonomous cart can: receive a request for materials, such as by an operator via a display on the autonomous cart and/or via an operator device associated with the operator; generate a loading instruction containing the set of requested materials; and transmit this loading instruction to a loading operator at the loading area within the facility to assemble a particular tray containing the set of requested materials. The autonomous cart can then: maneuver to the loading area within the facility to trigger loading of the particular tray on the autonomous cart; and autonomously maneuver to the operator to deliver the particular tray to the operator.

In another implementation, the autonomous cart can: receive a request for materials by an operator; query a list of autonomous carts operating within the facility; identify a second autonomous cart in the list of autonomous carts containing the requested set of compliant materials; and maneuver the second autonomous cart to the target location proximal the operator to deliver the requested set of compliant materials.

### 9.2 Instruction Profile

Generally, the computer system can generate an instruction profile representing performance of tasks in the digital procedure by the operator. In particular, the computer system can: access a video feed from an optical sensor, such as mounted at a make line within the facility and/or integrated into an operator device (e.g., headset, tablet) during performance of the procedure; extract visual features from the video feed depicting the operator performing the procedure; interpret objects handled by the operator, actions performed by the operator, values output by equipment units during performance of steps in the procedure based on the extracted visual features; and represent these objects and actions in an instruction profile representing performance of the procedure by the operator.

In one implementation, the computer system can: access a video feed depicting performance of the procedure by the operator; extract a first set of instruction features from the instruction video feed; and generate an instruction profile representing performance of the first task based on the first set of instruction features. The computer system can: identify multiple (e.g., “n” or “many”) features representative of performance of the digital procedure in a video feed; characterize these features over a duration of the video feed, such as over a duration corresponding to performance of a video feed in the digital procedure; and aggregate these features into a multi-dimensional feature profile uniquely representing performance of this digital procedure, such as duration of time periods, relative orientations, geometries, relative velocities, lengths, angles, etc. of these features.

In this implementation, the computer system can implement an instruction feature classifier that defines types of instruction features (e.g., corners, edges, areas, gradients, orientations, strength of a blob, etc.), relative positions and orientations of multiple instruction features, and/or prioritization for detecting and extracting these instruction features from the video feed. In this implementation, the computer system can implement: low-level computer vision techniques (e.g., edge detection, ridge detection); curvature-based computer vision techniques (e.g., changing intensity, autocorrelation); and/or shape-based computer vision techniques (e.g., thresholding, blob extraction, template matching) according the instruction feature classifier in order to detect instruction features representing performance of the digital procedure in the video feed. The computer system can then generate a multi-dimensional (e.g., n-dimensional) instruction feature profile representing multiple features extracted for a duration in the video feed.

In one example, the computer system can: in response to initialization of a first manufacturing operation by an operator, generate a prompt to the operator to record performance of the first task in the first manufacturing operation; access a video feed captured by an optical sensor depicting the operator performing this first manufacturing operation; and extract a set of features from the video feed. The computer system can then: identify a set of objects in the video feed based on the set of features, such as hands of an operator, equipment units handled by the operator during performance of the first manufacturing operation, a string of values on a display of an equipment unit; and generate an instruction profile for the first manufacturing operation including the set of objects identified in the video feed.

Therefore, the computer system can: identify objects in video feeds associated with performance of steps in the digital procedure; represent these objects in an instruction profile; and confirm presence of pertinent objects necessary for performing the digital procedure based on the instruction profile.

Furthermore, in this implementation, the computer system can interpret actions carried out by an operator during performance of steps of the digital procedure based on the set of features extracted from the instruction video feed. In one example of this implementation, the computer system can: identify a first object (e.g., a flask) in the video feed associated with performance of the first manufacturing operation in the digital procedure; identify a second object (e.g., hand of an operator handling the first object and/or equipment units) in the video feed associated with performance of the first manufacturing operation in the digital procedure; and track relative positions, paths, and velocities of these objects for a duration in the video feed corresponding to performance of the first manufacturing operation. The computer system can then implement template matching techniques for these relative positions, paths, velocities of these objects in order to identify actions performed by the operator in the video feed (e.g., filling the flask with a liquid substance). The computer system can then generate the instruction profile including the first object, the second object, and motion (e.g., velocities, path, location) of these objects during performance of the digital procedure.

Therefore, the computer system can: interpret actions carried out by operators depicted in the video feed; represent these actions in an instruction profile for steps of the digital procedure; and confirm presence of actions necessary for performing steps of the digital procedure based on the instruction profile.

### 9.3 Ad-Hoc Delivery: Task Time Duration

Generally, the computer system can identify deviations of a current time duration for a step in the procedure performed by an operator from a target time duration specified in the digital procedure. In particular, the computer system can: track a duration of time for performing a current instance of a task in the digital procedure; extract a target time duration for the first task specified in the digital procedure; in response to the duration of time for a current instance of the first task deviating from the target time duration, generate a prompt for selection of additional guidance materials associated with performance of the first task of the procedure; and serve this prompt to an operator device associated with the operator. Subsequently, in response to confirming selection of additional guidance materials by the operator, the autonomous cart can navigate to the operator performing the first task to deliver the additional guidance materials.

In one implementation, the computer system can: track time durations of operators for performing tasks of a procedure within the facility in a first step profile for the first task of the procedure; and, in response to a current time duration for a particular task deviating from a target time duration for performing the particular task defined in the digital procedure, generate a prompt to suggest additional materials for completing the particular task. In this implementation, an operator can deviate from their target time duration for a particular task because they are in need of additional materials to support and/or complete the assigned task within the facility. Alternatively, the autonomous cart can miss the target time window due to slower delivery time, canceling the delivery due to an obstruction in the pathway, being unable to open a rollup door to enter the facility, or other reason the autonomous cart needs to deviate from the path or cancel its route. A supplemental autonomous cart containing the materials for the execution of the next step. If this supplemental autonomous cart is also unable to deliver the materials, the operator can be informed of this delay based on the issues along the path to the operator or delivery location where the operator can come out to meet the autonomous cart to manually remove any obstructions. Thus, the computer system can: track time durations for preforming these tasks in procedures; and recommend supplemental materials to aid the operator in completing their assigned task. The autonomous cart can then deliver these supplemental materials to the operator.

In one example, the computer system can: track time durations of operators for performing tasks of a procedure within the facility; and identify a time duration for a first task exceeding a target time duration for the first task defined in the digital procedure. Additionally, the computer system can, in response to identifying the time duration of the first task exceeding the target time duration: generate a prompt defining a list of supplemental materials (e.g., AR/VR/Mixed Reality headset, AR tablet) corresponding to a particular degree of guidance for the first task in the procedure; and serve this prompt to the operator, such as via a display at the autonomous cart and/or an operator device associated with the operator.

Thus, the autonomous cart can: receive selection of additional guidance from the operator performing the first task; and autonomously maneuver to a loading area within the facility to retrieve the supplemental materials (e.g., VR headsets, AR headsets, AR autonomous cart) for the additional guidance.

In one variation of this example, the computer system can: query a list of autonomous carts operating throughout the facility; identify a second autonomous cart in the list of autonomous carts containing the supplemental materials; and trigger maneuvering of the second autonomous cart to the target location proximal the operator to deliver the supplemental material.

In another example, the computer system can: track time durations of operators for performing tasks of a procedure within the facility; and identify a time duration for a first task falling below a target time duration for the first task (i.e., the operator is ahead of the loading schedule) defined in the digital procedure. In this example, the autonomous cart can, in response to identifying the time duration of the first task falling below the target time duration: maneuver the autonomous cart to the loading area within the facility to retrieve a second tray corresponding to the next task in the procedure; and trigger delivery of the second tray to the operator at the target location within the facility. Alternatively, the computer system can: query a list of autonomous carts operating throughout the facility; identify a second autonomous cart in the list of autonomous carts containing the second tray containing the second set of compliant materials for performing the second task; and trigger maneuvering of the second autonomous cart to the target location proximal the operator to deliver the second tray.

Therefore, the autonomous cart can autonomously deliver supplemental materials and/or materials for performing tasks in a procedure in order to support an operator in maintaining a target time duration for performing tasks of a procedure within the facility.

### 9.4 Ad-Hoc Delivery: Step Deviations

In one implementation, the computer system can: identify a deviation for the instruction profile exceeding a threshold deviation from a target instruction profile defined in the digital procedure; in response to identifying the deviation exceeding the threshold deviation, generate a prompt to notify a user of the deviation and suggest additional materials for completing the particular task; and serve this prompt to the operator performing the procedure, such as via a display on the autonomous cart and/or an operator device associated with the operator. The autonomous cart can then: receive selection of supplemental materials (e.g., AR/VR/Mixed Reality headsets for guidance, a set of compliant materials to perform the first task again) for a current task being performed; and maneuver the autonomous cart to the loading area within the facility to retrieve the supplemental materials for performing the first task of the procedure.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for autonomously delivering materials to operators performing procedures within a facility, the method comprising:
during a first time period:
ccessing a loading schedule defining:
a first manufacturing operation scheduled for execution at a target location within the facility; and
a first materials manifest specifying compliant materials associated with performance of the first manufacturing operation;
identifying a first compliant materials tray, in a set of trays at the loading system, comprising a set of compliant materials corresponding to the first materials manifest for the first manufacturing operation;
in response to identifying the first compliant materials tray:
assigning a first delivery location, proximal the target location within the facility, to the first compliant materials tray;
assigning a first delivery trigger, based on the first manufacturing operation, to the first compliant materials tray; and
assigning a baseline material compliance score, representing a compliance status of the first compliant materials tray, to the first compliant materials tray; and
triggering the loading system, arranged within a sanitary zone at the facility, to load the first compliant materials tray onto an autonomous cart proximal the loading system; and
during a second time period following the first time period:
in response to detecting the delivery trigger, triggering the autonomous cart to maneuver the first compliant materials tray from a first zone at the facility to the first delivery location within a second zone at the facility;
accessing a timeseries of locations traversed by the autonomous cart within the facility between the first zone and the second zone;
calculating a first materials compliance score, different from the baseline materials compliance score, of the first compliant materials tray based on the timeseries of locations; and
in response to the first materials compliance score exceeding a threshold materials compliance score, triggering the autonomous cart to maintain a target offset distance from a first operator scheduled to perform the first manufacturing operation.

2. The method of claim 1, wherein calculating the first materials compliance score comprises:
accessing a facility map representing the facility and defining:
the sanitary zone; and
a contamination zone comprising a set of regions, each region in the set of regions defined by a contamination exposure score;
identifying a first location in the timeseries of locations corresponding to a first region, in the set of regions of the contamination zone, associated with a first contamination exposure score;
identifying a second location in the timeseries of locations corresponding to a second region, in the set of regions of the contamination zone, defined by a second contamination exposure score; and
calculating the first materials compliance score based on a combination of the first contamination exposure score, the second contamination exposure score, and the baseline materials compliance score.

3. The method of claim 1, wherein calculating the first materials compliance score comprises:
accessing a first image captured at a first location, in the timeseries of locations, from a first optical sensor arranged at the autonomous cart and defining a field of view of the first compliant materials tray arranged on the autonomous cart;
extracting a first set of visual features from the first image;
interpreting a contamination event associated with the first compliant materials tray based on the first set of visual features from the first image, the contamination event defined by a contamination exposure score; and
calculating the first materials compliance score based on a combination of the contamination exposure score and the baseline materials compliance score.

4. The method of claim 1, wherein calculating the first materials compliance score comprises:
detecting removal of the first compliant materials tray from the autonomous cart at a first location in the timeseries of locations;
in response to detecting removal of the first compliant materials tray, receiving a set of operator credentials from a second operator device associated with a second operator at the first location within the facility;
identifying the second operator as unauthorized to remove the first compliant materials tray from the autonomous cart based on the set of operator credentials; and
calculating the first materials compliance score based on the set of operator credentials and the first location.

5. The method of claim 1:
wherein accessing the loading schedule comprises accessing the loading schedule defining a first scheduled time window, within the second time period, for the first operator to perform the first manufacturing operation;
wherein assigning the delivery trigger comprises assigning the delivery trigger specifying a first time within the first time period and prior to the first scheduled time window;
wherein triggering the loading system comprises, at an initial time prior to the first time, triggering a robotic arm at the loading system to load the first compliant materials tray onto the autonomous cart located proximal the loading system; and
wherein detecting the delivery trigger comprises, at the first time, triggering the autonomous cart to maneuver the first compliant materials tray from the sanitary zone to the first delivery location.

6. The method of claim 1:
wherein assigning the delivery trigger comprises assigning the delivery trigger specifying:
an operator profile associated with the first operator; and
a first scheduled time window for the first operator to perform the manufacturing operation; and
wherein detecting the delivery trigger comprises:
at a first time, receiving a delivery request from a first operator device at the target location, the delivery request characterized by a set of operator credentials representing the first operator;
detecting the delivery trigger by identifying the first set of operator credentials as corresponding to the operator profile specified in the delivery trigger; and
in response to the first time falling within the scheduled time window, triggering the autonomous cart to maneuver the first compliant materials tray from the sanitary zone to the first delivery location.

7. The method of claim 1, wherein triggering the autonomous cart to maintain the target offset distance from the first operator comprises:
at the autonomous cart, accessing a live video feed from an optical sensor arranged on the autonomous cart and defining a field of view intersecting the target location within the facility;
extracting a first set of visual features from the live video feed;
interpreting a first offset distance between the autonomous cart and the first operator in the live video feed based on the first set of visual features;
in response to the first offset distance deviating from the target offset distance, triggering the autonomous cart to navigate to a second location offset from the first operator by the target offset distance; and
in response to the autonomous cart occupying the target offset distance from the first operator:
receiving a set of operator credentials from a first operator device associated with the first operator;
in response to authenticating the first operator to access the first compliant materials tray based on the set of operator credentials, generating a prompt to retrieve the first compliant materials tray from the autonomous cart; and
rendering the prompt at a display coupled to the autonomous cart.

8. The method of claim 1, wherein accessing the loading schedule comprises:
accessing a manufacturing operation schedule representing a sequence of manufacturing operations scheduled for performance at the facility;
identifying the first manufacturing operation in a manufacturing operation schedule;
extracting identities of a sequence of materials specified in a first step in the manufacturing operation;
identifying a first group of materials, in the sequence of materials, as corresponding to compliant materials associated with performance of the first step;
generating the first materials manifest for loading onto the autonomous cart prior to scheduled performance of the first step based on the first group of materials;
defining a first loading time for materials specified in the first materials manifest based on the scheduled time window for the manufacturing operation; and
aggregating the first manufacturing operation, the first materials manifest, and the first loading time for the materials specified in the materials manifest into the loading schedule.

9. The method of claim 8, further comprising:
at the first loading time, triggering the loading system to retrieve a first compliant material specified in the first materials manifest from the loading schedule;
triggering the loading system to load the first compliant material onto a first compliant materials tray within a first zone at the facility;
generating a first materials tag, in a materials library, defining a first identity for the first compliant material loaded onto the first compliant materials tray; and
triggering the loading system to load the first compliant materials tray into a shelf containing a set of trays within a first zone at the facility.

10. The method of claim 1:
wherein identifying the first compliant materials tray comprises:
accessing a materials library representing a set of trays arranged on a shelf proximal the loading system within a first zone;
identifying a first materials tag in the materials library representing a first group of compliant materials in the first materials manifest, the first materials tag corresponding to the first compliant materials tray arranged at a first location on the shelf; and
identifying a second materials tag in the materials library representing a second group of compliant materials in the first materials manifest, the second materials tag corresponding to a second compliant materials tray arranged at a second location on the shelf;
wherein triggering the loading system comprises triggering the loading system to:
retrieve the first compliant materials tray from the first location on the shelf;
load the first compliant materials tray onto the autonomous cart;
retrieve the second compliant materials tray from the second location on the shelf; and
load the second compliant materials tray onto the autonomous cart; and
wherein triggering the autonomous cart comprises triggering the autonomous cart to maneuver the first compliant materials and the second compliant materials tray from the a first zone to the first delivery location within a second zone at the facility.

11. The method of claim 1, further comprising during a third time period:
triggering the autonomous cart to maneuver a second compliant materials tray from the second zone to a second delivery location within a third zone at the facility;
accessing a second timeseries of locations traversed by the autonomous cart between the second zone and the third zone at the facility;
calculating a second material compliance score of the second compliant materials tray based on the second timeseries of locations and the baseline material compliance score; and
in response to the second material compliance score falling below a threshold material compliance score:
flagging the second compliant materials tray as containing contaminated materials disqualified for the first manufacturing operation; and
triggering the autonomous cart to maneuver to the loading system within the sanitary zone of the facility.

12. The method of claim 11, wherein calculating the second material compliance score comprises:
accessing an image captured at a second location, in the second timeseries of locations, from an optical sensor arranged at the autonomous cart and defining a field of view of the second compliant materials tray arranged on the autonomous cart;
extracting a second set of visual features from the second image;
interpreting a contamination event associated with the first compliant materials tray based on the first set of visual features from the image, the contamination event corresponding to unauthorized retrieval of compliant materials in the first compliant materials tray; and
in response to interpreting the contamination event, calculating the second material compliance score as falling below the threshold material compliance score.

13. The method of claim 1:
wherein assigning the delivery trigger comprises assigning the delivery trigger specifying a first equipment unit of a first equipment type associated with performance of the first manufacturing operation; and
wherein detecting the delivery trigger comprises:
accessing a first live video feed from a first optical sensor defining a first field of view intersecting the first operator at the target location;
extracting a first set of visual features from the first live video feed;
detecting the delivery trigger by interpreting the first operator proximal the first equipment unit in the first live video feed based on the first set of visual features; and
in response to detecting the delivery trigger, triggering the autonomous cart to maintain a target offset distance from an operator at the delivery location.

14. The method of claim 1, wherein triggering the autonomous cart to maneuver the first compliant materials tray comprises:
accessing a facility map representing a set of locations within the facility;
accessing a manufacturing operation schedule representing manufacturing operations scheduled for performance at target locations within the facility over a first duration of time;
generating a first set of labels specifying target locations for performing instances of manufacturing operations based on the manufacturing operation schedule;
assigning the first set of labels to a subset of locations, in the set of locations, in the facility map, the subset of locations comprising the target location;
calculating a first path from the first zone within the facility, containing the autonomous cart, to the delivery location within the second zone based on the facility map;
serving the first path to the autonomous cart; and
maneuvering the autonomous cart to the delivery location within the facility proximal the first location according to the first path.

15. The method of claim 1:
wherein accessing the loading schedule comprises accessing the loading schedule defining:
a first operator profile representing guidance preferences for the first operator scheduled to perform the first manufacturing operation; and
a first observer profile associated with a first observer viewing the first manufacturing operation;
wherein triggering the loading system comprises triggering a robotic arm to load a first mobile guidance device onto the autonomous cart based on the first operator profile; and
wherein triggering the autonomous cart to maintain the target offset distance from the first operator comprises:
at the autonomous cart, receiving a first set of operator credentials associated with the first operator; and
in response to separation of the first mobile guidance device from the autonomous cart:
associating a first mobile guidance device with the first operator according to the first set of operator credentials; and
serving a first video feed from the first mobile device to a first observer portal associated with the first observer based on the first observer profile.

16. A method for autonomously delivering materials to operators performing procedures within a facility, the method comprising:
identifying a manufacturing operation, in a manufacturing operation schedule, scheduled for performance at a target location within the facility during a scheduled time window;
extracting identities of a sequence of materials specified in a first step in the manufacturing operation;
identifying a first group of materials, in the sequence of materials, as corresponding to compliant materials associated with performance of the first step;
assigning, to the first group of materials:
a loading time based on the scheduled time window;
a first delivery location proximal the target location within the facility;
a first delivery trigger based on the first step; and
a baseline material compliance score representing a material compliance status of the first group of materials at a first time;
at a loading system located within a first zone at the facility:
at the loading time, retrieving the first group of materials; and
autonomously loading the first group of materials onto an autonomous cart proximal the loading system;
in response to detecting the delivery trigger, triggering the autonomous cart to maneuver the first group of materials across a timeseries of locations from the first zone to the first delivery location within a second zone at the facility;
calculating a first material compliance score of the first compliant materials tray based on the timeseries of locations and the baseline material compliance score; and
in response to the first material compliance score exceeding a threshold material compliance score, triggering the autonomous cart to maintain a target offset distance from an operator at the delivery location.

17. The method of claim 16, wherein calculating the first material compliance score comprises:
accessing a facility map representing the facility and defining:
the first zone corresponding to a sanitary zone within the facility; and
a contamination zone comprising a set of regions, each region in the set of regions defined by a contamination exposure score;
identifying a first location in the timeseries of locations corresponding to a first region, in the set of regions of the contamination zone, defined by a first contamination exposure score;
identifying a second location in the timeseries of locations corresponding to a second region, in the set of regions of the contamination zone, defined by a second contamination exposure score; and
calculating the first material compliance score based on a combination of the first contamination exposure score, the second contamination exposure score, and the baseline material compliance score.

18. The method of claim 16:
wherein identifying the first compliant materials tray comprises:
accessing a materials library representing a set of trays arranged on a shelf proximal the loading system within the sanitary zone;
identifying a first materials tag in the materials library representing the first group of materials in the first materials manifest, the first materials tag corresponding to a first compliant materials tray arranged at a first location on the shelf; and
identifying a second materials tag in the materials library representing a second group of materials in the first materials manifest, the second materials tag corresponding to a second compliant materials tray arranged at a second location on the shelf;
wherein triggering the loading system comprises triggering the loading system to:
retrieve the first compliant materials tray from the first location on the shelf;
load the first compliant materials tray onto the autonomous cart;
retrieve the second compliant materials tray from the second location on the shelf; and
load the second compliant materials tray onto the autonomous cart; and
wherein triggering the autonomous cart comprises triggering the autonomous cart to maneuver the first compliant materials tray and the second compliant materials tray from the first zone to the first delivery location within the second zone at the facility.

19. The method of claim 16, further comprising, at the autonomous cart:
accessing a live video feed from an optical sensor arranged at the autonomous cart and defining a field of view intersecting the target location within the facility;
extracting a first set of visual features from the live video feed;
interpreting a first offset distance between the autonomous cart and the operator in the live video feed based on the first set of visual features;
in response to the first offset distance deviating from the target offset distance, triggering the autonomous cart to navigate to a second location offset from the first operator by the target offset distance; and
in response to the autonomous cart occupying the target offset distance:
receiving a set of operator credentials from an operator device associated with the first operator;
in response to authenticating the operator to retrieve the first group of materials based on the set of operator credentials, generating a prompt requesting the operator to retrieve the first group of materials from the autonomous cart; and
serving the prompt at a display coupled to the autonomous cart.

20. A method for autonomously delivering materials to operators performing procedures within a facility, the method comprising:
accessing a loading schedule defining a first materials manifest specifying compliant materials associated with performance of a first manufacturing operation within the facility;
in response to identifying a set of compliant materials at the loading system corresponding to the first materials manifest for the first manufacturing operation, assigning the set of compliant materials:
a first delivery location within the facility;
a first delivery trigger based on the first manufacturing operation; and
a baseline material compliance score representing a compliance status of the first set of compliant materials;
triggering the loading system, at a first zone within the facility, to load the set of compliant materials onto an autonomous cart proximal the loading system;
in response to detecting the delivery trigger, triggering the autonomous cart to maneuver the first set of compliant materials across a timeseries of locations from the first zone to the first delivery location within a second zone at the facility;
calculating a first material compliance score of the first set of compliant materials based on the timeseries of locations and the baseline material compliance score; and
in response to the first material compliance score exceeding a threshold material compliance score, triggering the autonomous cart to maintain a target offset distance from the operator at the delivery location.
